(19) United States
(12) Patent Application Publication
(10) Pub. No.: US 2017/0251334 A1
(43) Pub. Date: Aug. 31, 2017

(54) METHOD AND SYSTEM FOR ACQUIRING KNOWLEDGE OF PROXIMITY OF AN ELECTRONIC DEVICE BY ANOTHER DEVICE FOR ESTABLISHING COMMUNICATION

(71) Applicant: CUMBARI AB, Stockholm (SE)

(72) Inventors: Kent BOGESTAM, Hagersten (SE); Harald HYNELL, Stockholm (SE)

(21) Appl. No.: 15/324,912

(22) PCT Filed: Jul. 9, 2015
(86) PCT No.: PCT/SE2015/000045

§ 371 Date: Jan. 9, 2017

(30) Foreign Application Priority Data
Jul. 9, 2014 (SE) 1430101-4

(51) Int. Cl. H04W 4/02; H04W 4/00; H04W 76/02

(52) U.S. Cl. CPC H04W 4/023; H04W 76/02; H04W 4/008

(57) ABSTRACT

A method and system for acquiring knowledge of proximity of an electronic device by another device for the purposes of establishing communication therewith. The knowledge of proximity of one electronic device is acquired by the other device through detection of spacial and temporal positioning and/or movement of one device with respect to the other device.

### FIELD OF THE INVENTION

The present invention relates to a method and system for acquiring knowledge of proximity of an electronic device by another device for the purposes of establishing communication therewith. In particular, the present invention provides a method and system for acquiring knowledge of proximity of one electronic device by the other device through detection of spacial or temporal movement or placement of one device with respect to the other device.

### BACKGROUND OF THE INVENTION

The popularity and functionality of portable electronic/communication devices has resulted in their use in an increasingly large array of day-to-day applications. Many of these application, such as particularly in the field of commerce, finance, entertainment etc., require an electronic/communication device to identify the other devices/platforms in close proximity and establish a communication therewith for performing a variety of functions, such as for e.g. data transfer/exchange or the use of mobile phones to conduct financial transactions or redemption of coupons at point-of-sale (POS) terminals, entering multi-user gaming consoles, etc. In the field of e-commerce involving financial transactions, such proximity based communications of the electronic devices not only serves as simple, efficient and economical methods, but are also much faster, safer and accurate at the same time. In order to enable these proximity based communications in a successful and accurate manner, however, three basic functions are usually required to be performed—(i) acquisition of knowledge of proximity by an electronic device (detecting device) of other electronic devices in the communication range; (ii) identification and selection by the detecting device of the desired device in the communication range (target device) with which it intends to establish communication; and (iii) establishment of communication by the detecting device with the target device. For example, at mobile payments platforms, the POS needs to particularly identify which devices likes to be connected and then connect with the particular device.

There are several methods/means available for close-proximity or proximity-based communication among electronic communication devices, such as through Bluetooth, radio frequency identification (RFID), near field communication (NFC), sound based communication, etc. Most of the existing devices are configured with one or more of these systems for establishing communication. However, these proximity-based communication systems are configured to function only once the devices are in close proximity (sufficient enough to initiate and maintain the communication) and already have the actual knowledge of such proximal presence of each other within the communication range. Hence, an accurate and efficient detection of proximity is a pre-requisite to initiating a communication. Any error/loss in acquiring proximity data/knowledge increases the risk of protocol failure, false positives, wastage of battery, server problem with overload due to incorrect transactions, etc.

Therefore, it is evidently essential and critical in such proximity-based communications for the devices to discover proximity with high accuracy and efficiency. This is typically achieved with the help of one or more proximity sensors built-in the communication devices. A proximity sensor is usually a component in an object/device which emits an electromagnetic field or a beam of electromagnetic radiation (such as infrared rays), and looks for changes in the field or return signal to determine the proximity of another object/device. Different proximity sensors could be used depending on the target object.

The existing low-end mobile communication devices/phones available in the market are usually not equipped with proximity sensors, thereby disabling the devices to discover proximity of another device. Although such low-end mobile phone communication devices are frequently equipped to establish communication through some proximity-based communication system (such as Bluetooth, etc.), lack of a proximity sensor serves a handicap in establishing communication with another device in real time close proximity. For such devices, therefore, there is a dire need to have an alternative model/arrangement for enabling detection of proximity of other devices accurately in real time.

The existing high-end electronic communication devices (such as smartphones and wireless devices), on the other hand, although do have one or more proximity sensors such as an Infrared (IR) Sensor (which is the most common and used almost invariably in all high end electronic communication devices), such proximity sensors are mostly placed (within the device) on the front side [viz. on screen-side] of the device/phone usually to detect (and skip) any accidental touchscreen taps when held closer to the ear during a call and/or also to switch off the display during calls to save battery. There is usually no other proximity sensor placed on any other side of these devices. Therefore, in order to employ the proximity sensor for discovering the proximity of other devices within the communication range and to establish communication therewith, the user will have no option but to use the front/screen-side of the detecting device. Whilst the front/screen-side can be used to discover proximity of other devices and collect the proximity data, it poses several practical challenges to the users in engaging the same front/screen-side of the device also for establishing communication with the target device using the acquired proximity data. Firstly and most importantly, the communication devices wherein the communicating antenna/chip (transponder/receiver) of the proximity-based communication system [such as NFC (Near Field Communication), RFID (Radio-frequency identification) or sound based system] is placed on the back side of the device, as is mostly the case, it is not possible to use of front-screen-side of the device to establish communication with other devices in proximity. In these devices, only the back-side of the device (having the proximity-based communication system) can be used for establishing communication. Likewise, in most cases, since the speakers are also commonly based on the back side of the device, the sound based connection can also be effectuated only through the back side of the device. Therefore, since most of the devices have the communicating means placed on the back side of the device and proximity sensor (which is usually the IR sensor) on the front-side of the device, technically, neither of the sides, by itself, is capable of completing the process of acquiring knowledge of proximity of the other device(s) as well as establishing communication therewith.

Furthermore, it is desirable that while a device is attempting to detect proximity of another device/platform and initiating communication therewith, the user has a direct access to the user-interface of the device (viz. its screen-side). This enables the user to enter command inputs, select which device to connect with amongst a plurality of devices in proximity and other functions. It is for this reason also, it is neither desirable nor feasible to have the front/screen-side of the device being used for detecting proximity. However, since the proximity sensors, typically IR sensors, are based on the screen side only, this poses a technical difficulty. It is, therefore, required to have a method for detection of proximity by an electronic device of other device(s) using the back-side of the device (and so as to establish communication with the device in continuation therefrom). Although, it may be technically possible to place another proximity sensor on the back-side of the communication device in order to overcome this difficulty, but may require manufacturing task and complexity and may not be desirable. Thus, it is desirable to be able to detect the proximity of a device without actually requiring to have a separate physical proximity sensor placed within the device and also without requiring the need to use conventional IR based sensors.

Also, the proximity-based communication system used in the existing devices [such as NFC (Near Field Communication), RFID (Radio-frequency identification) or sound based systems] require a continuous usage of battery during the long process of detection of other devices and establishing communication therewith. It is therefore desirable that the detection of an electronic device by the other device us instantaneous so as to minimize the usage of battery.

Accordingly, in view of the above, the need exists for a method and system which enables electronic devices to be able to discover or acquire the knowledge of the proximity of the other device(s) for the purpose of establishing communication therewith while overcoming the drawbacks of the prior art.

### OBJECTS OF THE INVENTION

The main object of the present invention is to provide a method and system for discovery of proximity of an electronic device by another device for the purposes of establishing communication therewith, which overcomes some or all of the limitations associated with the prior art.

Accordingly, one of the objects of the present invention is to provide a method and system for enabling an electronic device to acquire knowledge of proximity of other device(s) without requiring the need of conventional proximity sensors (typically IR based sensors).

Another object of the present invention is to provide a method and system for enabling an electronic device to acquire knowledge of proximity of other device(s) wherein the screen-side (GUI) of at least one and preferably each of the devices is directly accessible to the user for command-editing.

Yet another object of the present invention is to provide a method and system for enabling an electronic device to acquire knowledge of proximity of other device(s) wherein it doesn't require any continuous running battery support for the same.

Another object of the present invention is to provide a method and system for enabling an electronic device to acquire knowledge of proximity of other device(s) wherein the method/system is more accurate, secure, fast, safe and runs in real time.

The other objects and preferred embodiments and advantages of the present invention will become more apparent from the following description of the present invention when read in conjunction with the accompanying examples, figures and tables, which are not intended to limit scope of the present invention.

### SUMMARY OF THE INVENTION

The present invention provides a method for acquiring knowledge of proximity by an electronic device (D1) of another device (D2), the said method comprising detection of spacial and temporal positioning and/or movement of one device (D2) with respect to the other device (D1) wherein the said positioning and/or movement is detected by detection of variation in the magnetic field around the first device (D1) due to interference by the magnetic field of proximating second device (D2), and/or by the placement of the second device (D2) for at least a minimal duration of time at a relatively designated position with respect to the first device (D1).

The present invention also provides a system for enabling an electronic device (D1) for acquiring knowledge of proximity of another electronic device (D2), the said system comprising a plurality of electronic devices (D1 and D2) within close proximity to each other; and a means configured with at least one of the said electronic devices (D1) for detection of spacial and temporal positioning and/or movement of another device (D2), wherein the said means enables detection of variation in the magnetic field by first device (D1) due to interference by the magnetic field of other proximating second device (D2) and/or enables detection of placement of one second device (D2) for at least a minimal duration of time at a relatively designated position with respect to first device (D1)

### BRIEF DESCRIPTION OF THE DRAWINGS

FIG. 1 illustrates the magnetic field around an electronic device, depicted through vector fields.

FIG. 2 illustrates the magnetic fields around the two proximating devices (D1 & D2), depicted through vector fields.

FIG. 3 illustrates the graphical representation [Magnetic Field (in μT) v. Time graph] of the variation in the magnetic field with the proximating devices as compared to the individual device.

FIGS. 4 & 5 illustrates, without any limitation, several possible arrangements for proximation/placement of devices

FIGS. 6 & 7 illustrates the placement of a device D2 at a designated angle with respect to the other device (D1).

FIG. 8 illustrates the use of an electronic device (D2) for purchase with a dispensing machine (D1), wherein the device is placed at a particular location for a minimal duration of time to effectuate the transaction.

### DETAILED DESCRIPTION AND PREFERRED EMBODIMENTS OF THE INVENTION AND DRAWINGS

In accordance with the present invention, therefore, a method and system is provided for acquiring knowledge of proximity of an electronic device by another device for the purposes of establishing communication therewith.

In order to establish a communication between two devices which are in close proximity to each other, the devices need first to know that they are sufficiently close to each other so that a communication can be established. It is observed by the inventor of the present invention that a device can discover the proximity of another device without requiring the conventional proximity sensors by detecting the spacial and/or temporal positioning and/or movement of the other device(s) within the communication range. In accordance with one of the general embodiment of the present invention, therefore, an electronic device acquires the knowledge of proximity of other device(s) by detection of spacial and/or temporal positioning and/or movement of the other device(s). Likewise, a plurality of devices can discover the proximity of each other by detection of spacial and/or temporal positioning and/or movement of the device with respect to each other.

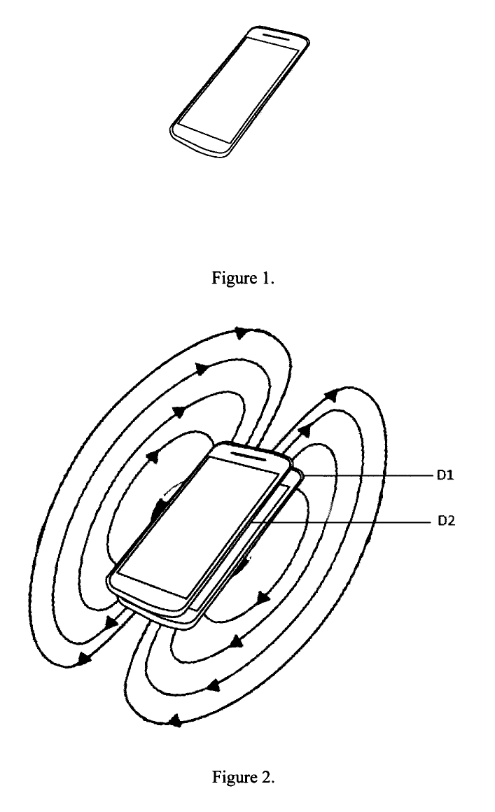

In accordance with one of the preferred embodiments of the present invention, the proximity of an electronic device (target device, D2) can be discovered by another device (detecting device, D1) by the detection of movement of the target device (D2) in close proximity of the detecting device (D1). The said movement of the target device, in accordance with a preferred embodiment of the present invention, is detected by detection of variation in the magnetic field around the detecting device (D1). A magnetic field is the magnetic influence of electric currents and/or magnetic materials and at any given point, magnetic field of an object is specified by direction and a magnitude/strength. All communication devices, such as mobile phones, etc. have a magnetic field around them, as depicted by vector lines in FIG. 1. The magnetic field around a device starts variating when it comes in close proximity with another ferrous/magnetic material or device possessing its own magnetic field. Such variation in the magnetic field is found by the inventors of the present invention to not only be sufficient but also an effective, efficient, economic and secure mechanism for acquiring knowledge of the presence of another device in proximity for the purpose of initiation of communication therewith. The variation in the magnetic field is depicted by the vector lines in the FIG. 2 and is graphically represented in FIG. 3. This variation could be detected by the device to discover the presence of another device in close proximity (viz. close enough to establish communication therewith).

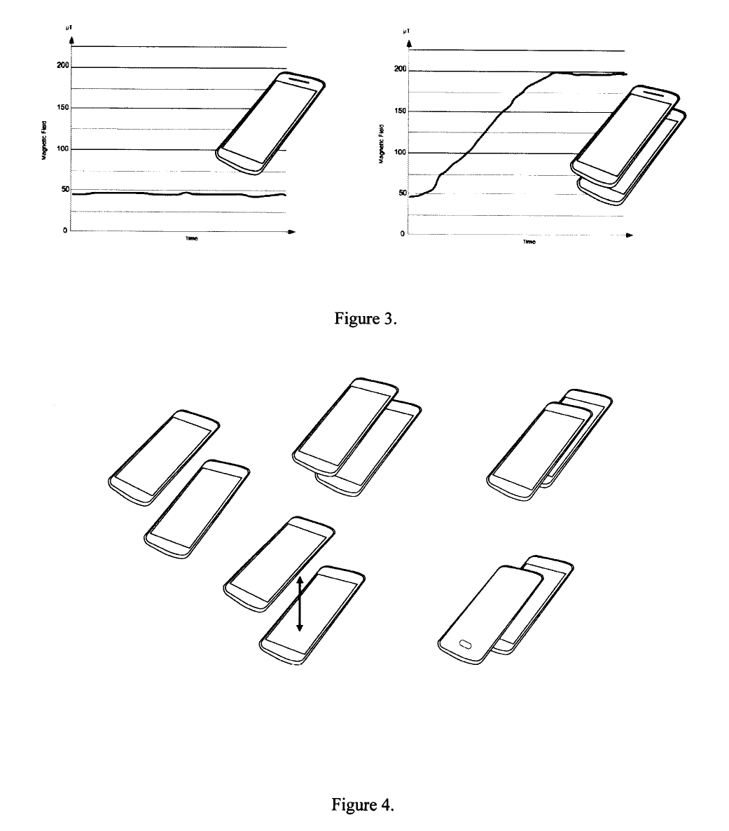

In accordance with another preferred embodiment of the present invention, when the first device awaits for the second device to be placed on the top or close to the first device, the magnetic field on each of the devices start to variate as soon as the second device is placed on top of the first device or even brought in close proximity to the first device and this variation in magnetic field triggers initiation of the establishment of communication. The conventional proximity sensors such as IR sensors of the devices, if any, are therefore not required to be engaged for the purposes of discovery of proximity of devices. Also, since the magnetic field of a device is uniform and bears no correlation with the screen/front side of the device, the devices can be brought proximate from the back side or even sideways, thereby allowing the users to access the screen for detection as well as establishing communication. This is illustrated in the arrangements of proximity of devices in FIGS. 4 & 5.

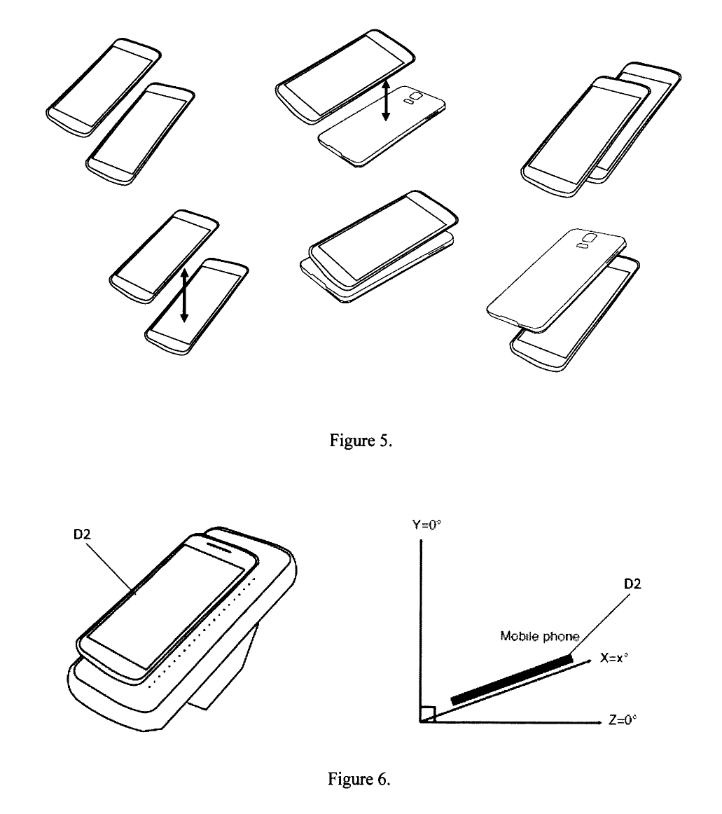

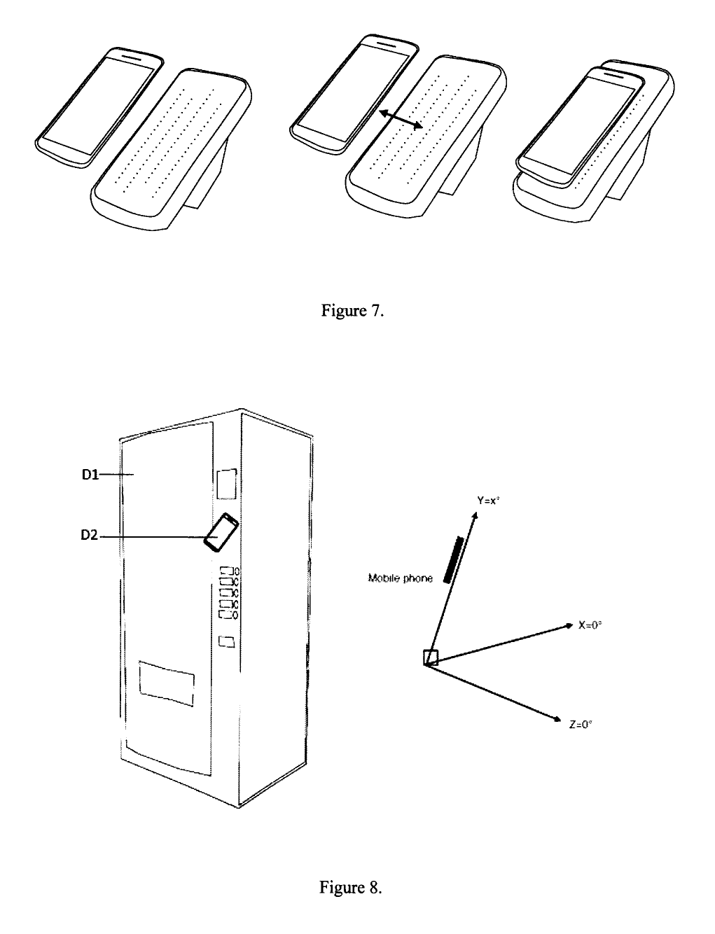

In accordance with yet another preferred embodiment of the present invention, the proximity of an electronic device (target device, D2) can be discovered by another device (detecting device, D1) by the detection of placement of the target device in close proximity of the detecting device. In particular, the proximity is discovered by detection of placement of the target device at a designated location and time (such as for e.g. at a specified angle for a minimal duration of time) with respect to the detecting device. In a most preferred embodiment of the invention, for e.g., if a user (Device D2) intends to establish communication with another device (D1), it places the D2 at a designated platform, which lets D1 know of the proximity as well as intention of D2 to establish communication. Device D1 is configured to detect the proximity of any other device which is placed at a pre-fixed location (such as for e.g. at an angle of x□ on its x-axis, as depicted in FIG. 6) with respect to D1 for at least a minimum duration of time (such as for e.g. 25 μs). In this manner, therefore, the devices need not employ or rely upon their conventional proximity sensors such as IR sensors for the discovery of proximity. Also, the device can be placed in any orientation, viz. the user can keep the screen-side up so as to be able to access the screen while the discovery as well as during establishing the communication.

For an illustration, refer FIG. 6, wherein the Device D2 is placed at a platform P which is at an angle (x□) on x-axis to the Device D1, thereby enabling the devices to discover the proximity and establishing communication. This may be done by using the accelerometer on the device and the configuration of the device may be static or dynamic. In accordance with this embodiment, discovery of a device is done by assuming that the device that wants to be discovered has a fixed position and as soon as the device assumes the expected position it is considered to be proximal to the first device. In one of the examples, the discovering object is expecting that when it has a particular position (X axis=0°, Y axis=0° and Z axis=20°) and the time it remains in this position is more than 200 milliseconds, it will assume that wanted object is discovered.

In accordance with the method and system as provided in the present invention, the knowledge of proximity of another device is obtained instantaneously without any delay, which minimizes power consumption thereby elongating the battery life. In the existing proximity based communication systems [such as RFID, NFC, Bluetooth, sound based, etc.], the time taken for acquiring knowledge of proximity, such as for searching to a NFC peer or the time to process the sound library etc. is too large and requires a continuous use of battery for long. The present invention therefore, significantly minimizes the use of battery during the process of establishing communication, for e.g. in sound based systems, instead of analyzing sound for 2 minutes the present invention can limit the analyzing time to 4 seconds.

In another embodiment of the present invention, it is stated that, the provided method and system enables an electronic device to be detected by and detect a plurality of other devices simultaneously.

Although the present invention has been described in considerable detail with reference to certain preferred embodiments and examples thereof, other embodiments and equivalents are very much possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms in which the appended claims are expressed. Thus various modifications are possible of the presently disclosed method and system without deviating from the intended scope and spirit of the present invention. More particularly, the method as depicted in the present invention, is simplified and generalized one and there are several trivial variations possible. Accordingly, in one embodiment, such modifications of the presently disclosed method of acquiring knowledge of proximity are included in the scope of the present invention. In addition to the method, there are functional variants of the presently disclosed system, all of which are included in the scope of the present invention.

I/We claim:

1. A method for acquiring knowledge of proximity by an electronic device (D1) of another device (D2), the said method comprising detection of spacial and temporal positioning and/or movement of one device (D2) with respect to the other device (D1) wherein the said positioning and/or movement is detected by detection of variation in the magnetic field around the first device (D1) due to interference by the magnetic field of proximating second device (D2), and/or by the placement of the second device (D2) for at least a minimal duration of time at a relatively designated position with respect to the first device (D1).

2. A method as claimed in claim 1 wherein either or both of the said electronic devices (D1/D2) is/are a wireless portable device such as a portable communication device, a cellular/mobile phone, etc.

3. A method as claimed in claim 1 wherein either or both of the said electronic devices (D1/D2) is/are a computing device such as point-of-sales terminal, a gaming console, etc.

4. A method as claimed in claim 1 wherein the said knowledge of proximity acquired by one device of the other device is used to initiate a communication therewith.

5. A method as claimed in claim 4, wherein the said communication is established by proximity-based communication methods such as NFC, Bluetooth, RFID, sound-based, etc.

6. A method as claimed in claim 1 wherein the said detection of variation in the magnetic field by one device enables it to detect a plurality of devices in close proximity thereto.

7. A method as claimed in claim 1 wherein the said placement of one device for the said duration of time and position enables it to detect and be detected by a plurality of devices in proximity.

8. A system for enabling an electronic device (D1) for acquiring knowledge of proximity of another electronic device (D2), the said system comprising:
a. a plurality of electronic devices (D1 and D2) within close proximity to each other; and
b. a means configured with at least one of the said electronic devices (D1) for detection of spacial and temporal positioning and/or movement of another device (D2),
wherein the said means enables detection of variation in the magnetic field by first device (D1) due to interference by the magnetic field of other proximating second device (D2) and/or enables detection of placement of one second device (D2) for at least a minimal duration of time at a relatively designated position with respect to first device (D1).

9. A system as claimed in claim 8 wherein either or both of the said electronic devices (D1/D2) is/are a wireless portable device such as a portable communication device, a cellular/mobile phone, etc.

10. A system as claimed in claim 8 wherein either or both of the said electronic devices (D1/D2) is/are a computing device such as point-of-sales terminal, a gaming console, etc.

11. A system as claimed in claim 8 wherein the said knowledge of proximity acquired by one device of the other device is used to initiate a communication therewith.

12. A system as claimed in claim 11 wherein the said communication is established by proximity-based communication methods such as NFC, Bluetooth, RFID, sound-based, etc.

13. A system as claimed in claim 8 wherein the said detection of variation in the magnetic field by one device enables it to detect a plurality of devices in close proximity thereto.

14. A system as claimed in claim 8 wherein the said placement of one device for the said duration of time and position enables it to detect and be detected by a plurality of devices in proximity.
